(19) United States
(12) Patent Application Publication
(10) Pub. No.: US 2009/0172736 A1
(43) Pub. Date: Jul. 2, 2009

(54) INTERACTIVE MEDIA GUIDANCE APPLICATION WITH ACCESS TO MULTIPLE DATA PATHS

(75) Inventors: Mike H. P. Tsui, Taikoo Shing (HK); Jerry T. F. Fung, Kowloon (HK); Guy Y. K. Chow, Shatin (HK)

Correspondence Address: ROPES & GRAY LLP, PATENT DOCKETING 39/361, 1211 AVENUE OF THE AMERICAS, NEW YORK, NY, 10036-8704, US

(73) Assignee: United Video Properties, Inc., Los Angeles, CA (US)

(21) Appl. No.: 11/967,548

(22) Filed: Dec. 31, 2007

(51) Int. Cl. G06F 3/00

(52) U.S. Cl. 725/40

(57) ABSTRACT

Systems and methods for an interactive media guidance application with access to multiple data sets are provided. One of the data sets may be selected to generate a media guidance application display screen. A data set may be selected based on the data source or data path from which the data set was received. A data set may also be selected based on a quality measure value associated with the data set. Portions of two or more data sets may also be merged to form a combined data set.

### BACKGROUND OF THE INVENTION

Media delivery systems provide a substantial amount of media to users. Consequently, many users desire a form of media guidance through an interface that allows users to efficiently navigate among media selections and to easily identify media that they may desire. An application which provides such guidance is referred to herein as an interactive media guidance application or, sometimes, a media guidance application or a guidance application.

Interactive media guidance applications may take various forms and be implemented on various devices depending on the media for which they provide guidance. One typical type of media guidance application implemented on user television equipment is an interactive television program guide. Interactive television program guides (sometimes referred to as electronic program guides) are well-known guidance applications that, among other things, allow users to navigate among and locate many types of media content including conventional television programming (provided via a television network), as well as pay-per-view programs, on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc.

With the advent of the Internet, mobile computing, and high-speed wireless networks, users are accessing media and media guidance data on personal computers (PCs) and other devices on which they traditionally did not, such as hand-held computers, personal digital assistants (PDAs), mobile telephones, or other mobile devices. On these devices users are able to navigate among and locate the media that has traditionally only been available through a television. Consequently, media guidance is necessary on these devices as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on PCs, user television equipment, hand-held computers, PCs, PDAs, mobile telephones, or other devices that can connect to the Internet.

Although many types of media guidance applications are available, it is desirable to have a single media guidance application that can be accessed from multiple devices and platforms. Typical interactive media guidance applications are not configured to be compatible with multiple devices and platforms. Consequently, media information presented to a user may be in a confusing format when the user accesses the media guidance applications from a device that is incompatible with the device for which the information is configured. Systems and methods for providing a unified media guidance application interface across multiple devices and platforms, are discussed in, for example, commonly-assigned U.S. patent application Ser. No. 11/541,299 (attorney docket no. UV-421), filed Sep. 29, 2006, which is incorporated by reference herein in its entirety.

Even with a unified media guidance application interface format, because different devices and platforms have different levels of connectivity and therefore do not have access to the same of media guidance application data, each media guidance application must be configured to display a particular set of media guidance data. Furthermore, some devices and platforms have multiple levels of connectivity and have access to multiple sets of media guidance data. Therefore, there still exists a need for systems and methods that can provide a media guidance display that is generated with the media guidance data that is available at any particular device at any given time. There also exists a need for systems and methods that that can access multiple sets of media guidance data and that can generate a media guidance display with the data from the multiple data sets.

### SUMMARY OF THE INVENTION

In accordance with the principles of the present invention, interactive media guidance applications are provided that can generate interactive media guidance displays from available interactive media guidance application data sets. Various user equipment devices and platforms have different levels of connectivity. These various user equipment devices and platforms may have access to different sets of media guidance application data based on their connectivity. Some user equipment devices and platforms may have access to multiple sets of media guidance application data. When any one of the multiple data sets can be used to generate a particular interactive media guidance application display, these multiple data sets may be referred to as interchangeable data sets.

In some embodiments, each of the multiple sets of media guidance data may be associated with a quality measure value. The quality measure value may indicate the amount and type of media guidance data included in a particular set of data. For example, a media guidance data set with a low quality measure value may be used to generate a basic media guidance display, while a media guidance application with a high quality measure value may be used to generate an enhanced media guidance display. When two or more sets of media guidance application data are available, the media guidance application may compare quality measure values associated with the data sets and may select one of the sets based on the comparison. The media guidance application may then generate a media guidance application display with the selected data set.

In some other embodiments, the multiple sets of media guidance application data may be received by a user device from multiple data sources over multiple data paths. The data sources and data paths may be assigned different priority ratings. A set of media guidance data may be selected for display based on the priority of the data source or data path on which the data set was received.

In yet other embodiments, the multiple sets of media guidance application data may be combined to form a merged set of media guidance application data.

### BRIEF DESCRIPTION OF THE DRAWINGS

The above and other features of the present invention, its nature and various advantages will be more apparent upon consideration of the following detailed description of the disclosure, taken in conjunction with the accompanying drawings, in which like reference numerals refer to like parts throughout, and in which:

FIGS. 1-2 show illustrative grid program listings display screens in accordance with various embodiments of the present invention;

FIG. 3 shows an illustrative video mosaic program listings display screen in accordance with one embodiment of the present invention;

FIG. 4 shows a generalized embodiment of an illustrative an user equipment device in accordance with one embodiment of the present invention;

FIG. 5 shows a generalized embodiment of an illustrative interactive media guidance system in accordance with one embodiment of the present invention;

FIG. 6 shows a generalized embodiment of an illustrative interactive media guidance system in which a user equipment device receives two sets of media guidance data in accordance with one embodiment of the present invention;

FIG. 7 shows a generalized diagram which illustrates an exemplary technique for accessing multiple interchangeable media guidance data sets in accordance with one embodiment of the present invention;

FIG. 8 shows a generalized diagram which illustrates an exemplary technique for accessing and merging two media guidance data sets in accordance with one embodiment of the present invention;

FIGS. 9-10 show illustrative media guidance application display screens in accordance with various embodiments of the present invention;

FIGS. 11A, 11B, 12A, and 12B show illustrative media application display modules that may receive different media guidance application data sets in accordance with various embodiments of the present invention; and

FIGS. 13-16 are flow diagrams of illustrative processes that can be used in accordance with various embodiments of the present invention.

### DETAILED DESCRIPTION OF THE PREFERRED EMBODIMENTS

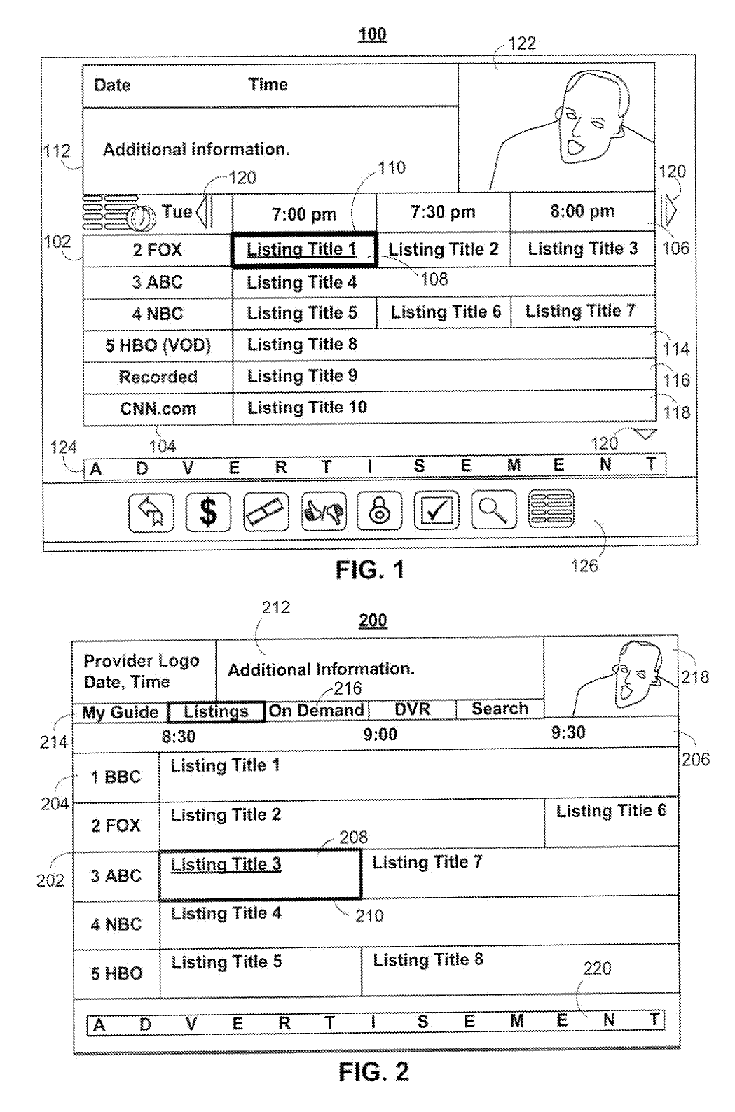

The following is a description of various media guidance application display screens, options, configurations and methods related to features in accordance with various embodiments of the present invention. The media guidance applications of the present invention may use one or more sets of media guidance data to generate display screens and available options (such as the illustrative display screens shown in FIGS. 1-3 and 9-12). These data sets may originate from one or more suitable data sources or data paths (which are discussed in more detail below, for example, in connection with FIGS. 4-8).

One of the functions of the media guidance application is to provide media listings and media information to users. FIGS. 1-3 and 9-12 show illustrative display screens and display screen modules that may be used to provide media guidance by, for example, presenting media listings and other selectable display components based on available guidance data. The display screens shown in FIGS. 1-3 and 9-12 may be implemented on any suitable device or platform and may be generated from any available set of media guidance data received from any suitable data source via any suitable data transmission scheme. While the displays of FIGS. 1-3 and 9-12 are illustrated as full screen displays, they may also be fully or partially overlaid over media content or other display screens being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide the appropriate display screen with media information organized in one of several ways, such as by time and channel in a grid, by time, by channel, by media type, by category (e.g., movies, sports, news, children, or other categories of programming), or other predefined, user-defined, or other organization criteria.

Display 100 of FIG. 1 is an illustrative grid program listings display arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Additional information relating to the program listing selected by highlight region 110 may be provided in program information region 112. Region 112 may include, for example, the program title, the program description, the time the program is provided (if applicable), the channel the program is on (if applicable), the program's rating, and other desired information.

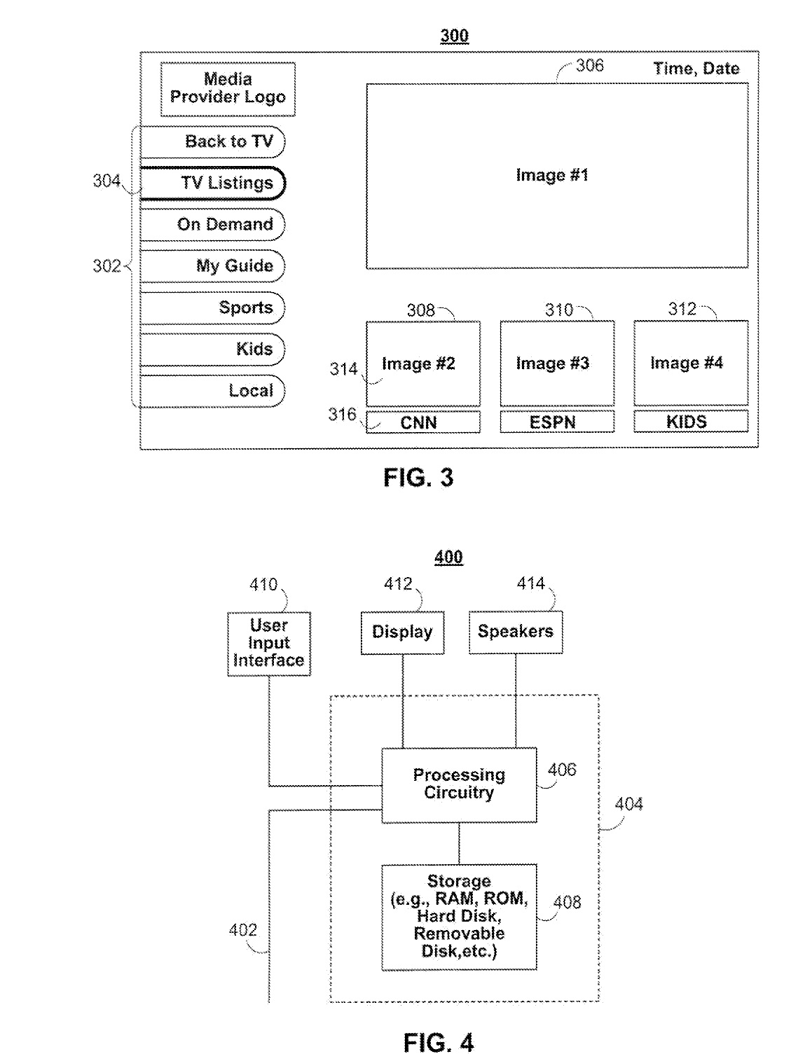

Although the program listings information shown in display 100 contains primarily text (e.g., the program titles) and icons, additional display information can also be displayed within the media guidance application display. For example, display 100 may include additional graphics or video information for one or more of the program listings. For ease of explanation, a program guidance application such as display 100 will be referred to herein as a containing basic media guidance application data. Similarly, a display that contains additional graphics or video information will be referred to herein as containing enhanced media guidance application data. In addition to containing additional graphics or video, media guidance displays containing enhanced media guidance application data may also contain additional quantities of information, more detailed information, more updated information, more customized information, etc. A media guidance application will have access to enhanced media guidance application data depending on whether the application has access to one or more data sources over one or more data transmission schemes. This will be described in greater detail below. However, other factors will also affect the level of data provided within a particular media guidance application display such as, for example, the display capabilities of a user equipment device generating the display, user preferences, and the nature of the display. Thus, even when enhanced media guidance application data is available, in some instances it may be preferable to limit the level of media guidance data provided within display 100 to avoid cluttering the display. In contrast, FIGS. 3, 11, and 12, which will be discussed in greater detail below, show illustrative displays in which either basic or enhanced media guidance data may be displayed.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO ON DEMAND™ providing THE SOPRANOS™ and CURB YOUR ENTHUSIASM™). HBO ON DEMAND™ is a service mark owned by Time Warner Company L. P. et al. and THE SOPRANOS™ and CURB YOUR ENTHUSIASM™ are trademarks owned by the Home Box Office, Inc. Internet content may include web events, such as a chat session or Webcast, or content available on-demand as streaming media or downloadable media through an Internet web site or other Internet access (e.g., FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on any type of use-related data (sometimes referred to herein as “user data”), such as, e.g., a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options. The options available within a display may be based on the available guidance data set.

Display 200 of FIG. 2 is another illustrative grid program listings display arranged by time and channel. Display 200 may include some components and interface features that are similar to or the same as those shown in display 200. In particular, display 200 is illustrated as including grid 202, channel/media type identifiers 204, and time identifiers 206, which respectively correspond to grid 102, channel/media type identifiers 104, and time identifiers 106 discussed above. Grid 202 also includes cells of program listings, such as program listing 208, where each listing provides the title of the program provided on the listing's associated channel and time. A user input device can be used as described above to interact with display 200 (e.g., moving highlight region 210) or any other display discussed herein in the same manner discussed above. Additional information relating to the program listing selected by highlight region 210 may be provided in program information region 212.

Tabs region 214 can be used to provide options that, when selected, allow the user to interact with various display screens. These display screens can include one or more customizable interactive user interfaces that deliver personalized media across multiple media platforms. For example, tabs region 214 can include one or more options that allow the user to access types of programming (such as, e.g., non-linear programming) that are not included in grid 202 and/or that are organized in a user-specific manner (as opposed to a traditional, system generated manner as shown in display 200). For example, in response to On Demand option 216 being selected, the media guidance application may present a listings grid or other type of display associated with On Demand programming and/or configuration settings. In some embodiments, grid 202 may also include listings for non-linear programming (not shown) and cause display 200 to be a mixed-media display.

Display 200 may also include video region 218 and advertisement 220, which may be similar to or the same as video region 122 and advertisement 124, respectively discussed above.

Another display arrangement for providing media guidance is shown in FIG. 3. Video mosaic display 300 includes selectable options 302 for media content information organized based on media type, genre, and/or other organization criteria. In display 300, television listings option 304 is selected, thus providing listings 306, 308, 310 and 312 as broadcast program listings. In display 300, the listings may provide graphical images including cover art, still images from the media content, video clip previews, live video from the media content, or other types of media that indicate to a user the media content being described by the listing depending on the available media guidance application data. If the graphical images are not provided by the available media guidance application data, the graphical images may be replaced by text or icons. Each of the graphical listings may also be accompanied by text to provide further information about the media content associated with the listing. For example, listing 308 may include more than one portion, including media portion 314 and text portion 316. Media portion 314 and/or text portion 316 may be selectable to view video in full-screen or to view program listings related to the video displayed in media portion 314 (e.g., to view listings for the channel that the video is displayed on).

The listings in display 300 are of different relative sizes (i.e., listing 306 is shown as being larger than listings 308, 310, and 312), but if desired all the listings may be the same size as shown in, e.g., FIG. 4. Listings may be of different sizes or graphically accentuated to indicate degrees of interest to the user or to emphasize certain content, as desired by the media provider or based on user preferences.

Various systems and methods for graphically accentuating media listings are discussed in, for example, Yates, U.S. patent application Ser. No. 11/324,202, filed Dec. 29, 2005, which is hereby incorporated by reference herein in its entirety.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information (which can be processed into machine-readable data) or may automatically compile user profile data. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

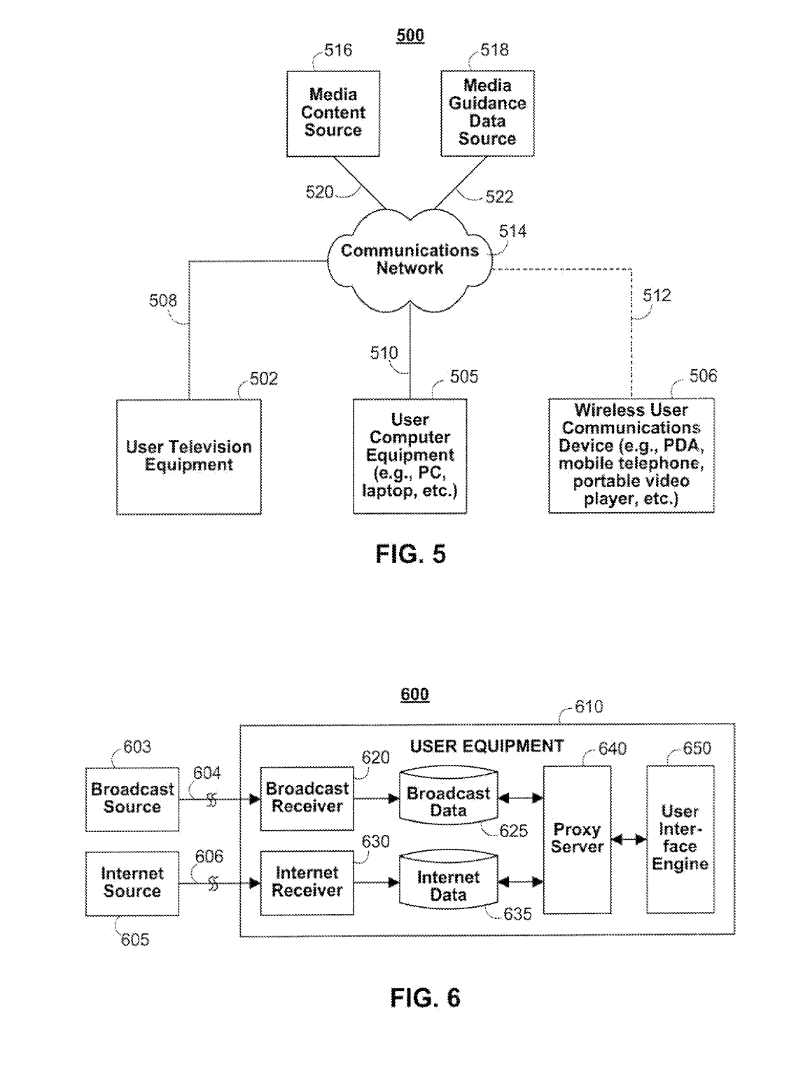

Users may access media content and media guidance application(s) (and their display screens described above and below) from one or more of their user equipment devices. FIG. 4 shows a generalized embodiment of illustrative user equipment device 400. More specific implementations of user equipment devices are discussed below in connection with FIGS. 5 and 6. User equipment device 400 may receive media content and one or more data sets via input/output (hereinafter “I/O”) path 402. I/O path 402 may provide media content (e.g., broadcast programming, on-demand programming, Internet content, and other video or audio) and data to control circuitry 404, which includes processing circuitry 406 and storage 408. Control circuitry 404 may be used to send and receive commands, requests, and other suitable data using I/O path 402. I/O path 402 may connect control circuitry 404 (and specifically processing circuitry 406) to one or more communications paths, as described in greater detail below. I/O functions may be provided by one or more of these communications paths, but are shown as a single path in FIG. 4 to avoid overcomplicating the drawing.

Control circuitry 404 may be based on any suitable processing circuitry 406 such as processing circuitry based on one or more microprocessors, microcontrollers, digital signal processors, programmable logic devices, etc. In some embodiments, control circuitry 404 executes instructions for a media guidance application stored in memory (i.e., storage 408). In client-server based embodiments, control circuitry 404 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 5). In addition, communications circuitry may include circuitry that enables peer-to-peer communication of user equipment devices, or communication of user equipment devices in locations remote from each other.

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 408 that is part of control circuitry 404. Storage 408 may include one or more of the above types of storage devices. For example, user equipment device 400 may include a hard drive for a DVR (sometimes called a personal video recorder, or PVR) and a DVD recorder as a secondary storage device. Storage 408 may be used to store various types of media described herein and one or more media guidance application data sets, including program information, guidance application settings, user preferences or profile information, or other data used in operating the guidance application. Nonvolatile memory may also be used (e.g., to launch a boot-up routine and other instructions).

Control circuitry 404 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 404 may also include scaler circuitry for upconverting and downconverting media into the preferred output format of the user equipment 400. Circuitry 404 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 408 is provided as a separate device from user equipment 400, the tuning and encoding circuitry (including multiple tuners) may be associated with storage 408.

A user may control the control circuitry 404 using user input interface 410. User input interface 410 may be any suitable user interface, such as a remote control, mouse, trackball, keypad, keyboard, touch screen, touch pad, stylus input, joystick, voice recognition interface, or other user input interfaces. Display 412 may be provided as a stand-alone device or integrated with other elements of user equipment device 400. Display 412 may be one or more of a monitor, a television, a liquid crystal display (LCD) for a mobile device, or any other suitable equipment for displaying visual images. In some embodiments, display 412 may be HDTV-capable. Speakers 414 may be provided as integrated with other elements of user equipment device 400 or may be stand-alone units. The audio component of videos and other media content displayed on display 412 may be played through speakers 414. In some embodiments, the audio may be distributed to a receiver (not shown), which processes and outputs the audio via speakers 414.

User equipment device 400 of FIG. 4 can be implemented in system 500 of FIG. 5 as user television equipment 502, user computer equipment 505, wireless user communications device 506, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 502 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 505 may include a PC, a laptop, a tablet, a WEBTV™ box, a personal computer television (PC/TV), a PC media server, a PC media center, or other user computer equipment. WEBTV is a trademark owned by Microsoft Corp. Wireless user communications device 506 may include PDAs, a mobile telephone, a portable video player, a portable music player, a portable gaming machine, or other wireless devices.

It should be noted that with the advent of television tuner cards for PC's, WEBTV™, and the integration of video into other user equipment devices, the lines have become blurred when trying to classify a device as one of the above devices. In fact, each of user television equipment 502, user computer equipment 505, and wireless user communications device 506 may utilize at least some of the system features described above in connection with FIG. 4 and, as a result, include flexibility with respect to the type of media content available on the device. For example, user television equipment 502 may be Internet-enabled allowing for access to Internet content, while user computer equipment 505 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 500, there is typically more than one of each type of user equipment device but only one of each is shown in FIG. 5 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

As discussed above, the user may also set various preferences or settings to maintain consistent media guidance application settings across in-home devices and remote devices. Settings can be saved as user data and include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, all of the user's equipment would be synchronized and the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application(s).

The user equipment devices may be coupled to communications network 514. Namely, user television equipment 502, user computer equipment 505, wireless user communications device 506 are coupled to communications network 514 via communications paths 508, 510, and 512, respectively. Communications network 514 may be one or more networks including the Internet, a mobile phone network, mobile device (e.g., BLACKBERRY™) network, cable network, public switched telephone network, or other types of communications network or combinations of communications networks. BLACKBERRY™ is a service mark owned by Research In Motion Limited Corp. Paths 508, 510, and 512, may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 512 is drawn with dotted lines to indicate that in the exemplary embodiment shown in FIG. 5 it is a wireless path and paths 508 and 510 are drawn as solid lines to indicate they are wired paths (although these paths may be wireless paths, if desired). Communications with the user equipment devices may be provided by one or more of these communications paths, but are shown as a single path in FIG. 5 to avoid overcomplicating the drawing.

Although communications paths are not drawn between user equipment devices, these devices may communicate directly with each other via communication paths, such as those described above in connection with paths 508, 510, and 512, as well as other short-range point-to-point communication paths, such as USB cables, IEEE 1394 cables, wireless paths (e.g., BLUETOOTH™, infrared, IEEE 802-11x, etc.), or other short-range communication via wired or wireless paths. BLUETOOTH™ is a certification mark owned by Bluetooth SIG, INC. The user equipment devices may also communicate with each other directly through an indirect path via communications network 514.

System 500 includes media content source 516 and media guidance data source 518 coupled to communications network 514 via communication paths 520 and 522, respectively. Paths 520 and 522 may include any of the communication paths described above in connection with paths 508, 510, and 512. Communications with the media content source 516 and media guidance data source 518 may be exchanged over one or more communications paths, but are shown as a single path in FIG. 5 to avoid overcomplicating the drawing. In addition, there may be more than one of each of media content source 516 and media guidance data source 518, but only one of each is shown in FIG. 5 to avoid overcomplicating the drawing. (The different types of each of these sources are discussed below.) If desired, media content source 516 and media guidance data source 518 may be integrated as one source device. Although communications between sources 516 and 518 with user equipment devices 502, 505, and 506 are shown as through communications network 514, in some embodiments, sources 516 and 518 may communicate directly with user equipment devices 502, 505, and 506 via communication paths (not shown) such as those described above in connection with paths 508, 510, and 512.

Media content source 516 may include one or more types of media distribution equipment including a television distribution facility, cable system headend, satellite distribution facility, programming sources (e.g., television broadcasters, such as NBC™, , ABC™, HBO™, etc.), intermediate distribution facilities and/or servers, Internet providers, on-demand media servers, and other media content providers. NBC™ is a trademark owned by the National Broadcasting Company, Inc., ABC™ is a trademark owned by the ABC, INC., and HBO™ is a trademark owned by the Home Box Office, Inc. Media content source 516 may be the originator of media content (e.g., a television broadcaster, a Webcast provider, etc.) or may not be the originator of media content (e.g., an on-demand media content provider, an Internet provider of video content of broadcast programs for downloading, etc.). Media content source 516 may include cable sources, satellite providers, on-demand providers, Internet providers, or other providers of media content. Media content source 516 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 518 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), graphical images (e.g., cover art, still images from the media content, etc.), video images (e.g., video clip previews, live video from the media content, etc.) on-demand information, and any other type of guidance data that is helpful for a user and other people to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 518 may be provided to user equipment using a client-server approach. For example, a guidance application client residing on the user equipment may initiate sessions with source 518 to obtain guidance data when needed. Media guidance data source 518 may provide user equipment devices 502, 505, and 506 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 404 of user equipment device 400 and partially on a remote server as a server application (e.g., media guidance data source 518). The guidance application displays may be generated by the media guidance data source 518 and transmitted to the user equipment devices. The media guidance data source 518 may also transmit data for storage on the user equipment, which then generates the guidance application displays based on instructions processed by control circuitry.

Media guidance system 500 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance.

The media guidance data provided from media guidance source 518 to a user equipment device over a communications path may be referred to herein as a set of media guidance data. The amount and type of media guidance application data in any particular set of media guidance application data may depend on the type of data paths and communications networks connecting the user equipment device to media guidance source 518. For example, different communications paths may have different amounts of bandwidth available to transmit media guidance data. This may limit the amount of media guidance data transmitted over a particular path to the user equipment device. Different data paths may also provide new or updated media guidance data with different regularity (e.g., continuously or at periodic intervals (daily, weekly, monthly, etc.)). Further, some data paths provide only one-way communication in which the user equipment only receives media guidance data broadcast by media guidance source 518 while other data paths provide two-way communications in which the user equipment may request specific media guidance data (i.e., to customize a media guidance display). For example, a set of media guidance application data received via broadcast data feed over a cable network may be more limited (i.e., a basic media guidance application data set) than a set of media guidance application data receive via the Internet (e.g., an enhanced media guidance application data set). A quality measure value may be associated with each media guidance data set to indicate the amount and type of media guidance application data in any particular set of media guidance application data.

As discussed above, user equipment devices can connect to media guidance data source 518 (or different media guidance data sources 518) over any number of different data paths and communications networks. In fact, some user equipment devices can connect to media guidance data source 518 over multiple paths either simultaneously or interchangeably. For example, a user television equipment device may connect to media guidance data source 518 via a broadcast data feed over a cable network and may also simultaneously connect to media guidance data source 518 (which may be the same data source or a different data source) via a connection to the Internet. As another example, a wireless user communications device 506 may be able to interchangeably access media guidance data source 518 via a high-speed wireless data path to the Internet and a low-speed wireless data path to the Internet, depending on the communications services available at the location of device. These devices may receive a different set of media guidance data via each of their data paths. As indicated above, the amount and type of data in each of the data sets may depend on the type of data path on which the data is received.

Furthermore, in some embodiments, each data set contains a complete set of media guidance data for a media guidance application display. That is to say that either data set may be used to generate the media guidance application display. When a user equipment device is provided with two or more of these interchangeable data sets, one data set may be selected based on a quality measure value associated with the data set and/or based on the data source or data path from which the data was received. In some other embodiments, the received data sets are not entirely interchangeable. For example, a first data set may contain basic media guidance data and a second data set may contain enhancements to the basic media guidance data without containing the actual media guidance data. Thus, the two data sets may be merged to generate a combined enhanced media guidance application display. In yet some other embodiments, portions of the data sets are interchangeable and portions of the data are not interchangeable. For example, a first data set may contain basic media guidance data while a second data set may contain enhanced media guidance data that is interchangeable with the basic media guidance data as well additional data that is not included with the first data set. Similarly the first data set may contain data that is not included with the second data set. It should be understood that a data set or portions of a data set may be interchangeable with another data set or portions of the other data set if the interchangeable portions of one data set may be used in place of or substituted for the interchangeable portions of the other data set. The interchangeable portions may have some data elements in common but may also contain data elements that are different. Each of these embodiments will be illustrated in greater detail with reference to the examples below.

System 600 of FIG. 6 is a more simplified version of system 500 (FIG. 5) in which a user equipment device is configured to receive two sets of media guidance data over two data paths from two media guidance sources. System 600 includes two media guidance data sources, broadcast source 603 and Internet source 605, and user equipment device 610. Broadcast source 603 and Internet source 605 may operate in a similar manner as media guidance data source 518 (FIG. 5) and user equipment device 610 may operate in a similar manner as user equipment 502, 505, and 506. Broadcast source 603 and Internet source 605 are depicted as separate media guidance data sources to more clearly indicate that each of there sources are providing separate sets of media guidance data over separate paths to user equipment 610. However, it should be understood that broadcast source 603 and Internet source 605 may also be a single media guidance data source that provides data over different data paths. Data paths 604 and 606 may be any suitable direct or indirect communications paths between a media guidance data source and user equipment as described above.

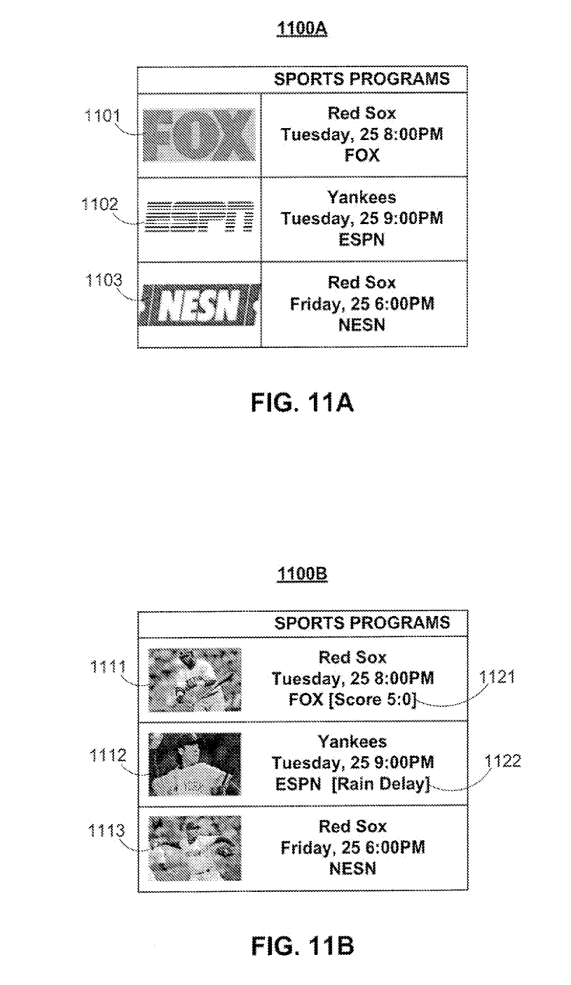

A first set of media guidance data may be transmitted from broadcast source 603 over broadcast data path 604 and may be received by user equipment on a television channel sideband, in the vertical blanking interval of a television channel, using an in-band digital signal, using an out-of-band digital signal, or by any other suitable broadcast data transmission technique. This data path may be a relatively low-bandwidth data path and accordingly the first set of media guidance data may have a relatively low quality measure value. For example, the first set of media guidance data may include relatively basic media guidance data such as broadcast times, broadcast channels, media titles, media descriptions, ratings information but may not include graphics or video data. For example, as will be described in greater detail below, the display module shown in FIG. 11A may represent a media guidance display that is generated using this first set of media guidance data.

A second set of media guidance data may be transmitted from Internet source 605 over Internet data path 606 and may be received by user equipment using any suitable Internet data link. This data path may be a relatively high-bandwidth data path and accordingly the second set of media guidance data may have a relatively high quality measure value. In some embodiments, this second set of media guidance data is locally stored (i.e., cached) and may be accessed even when there is not an active data path from the user device to the Internet. In some other embodiments, the second set of media guidance data is not locally stored and is accessed via a data path to the Internet whenever it is accessed. For example, the second set of media guidance data may include relatively basic media guidance data as well as enhanced media guidance data such as graphics and video data. As will be described in greater detail below, the display module shown in FIG. 11B may represent a media guidance display that is generated from this second set of media guidance data.

The first and second sets of media guidance data are received by broadcast receiver 620 and Internet receiver 630, respectively. These receivers may be any suitable data receivers for receiving media guidance data over data paths 604 and 606. The first set of media guidance data, received from broadcast source 603, may be stored in broadcast media guidance data storage 625. The second set of media guidance data, received from Internet source 605, may be stored in Internet media guidance data storage 635. Data storage 625 and 635 may be located, for example, within storage 408 (FIG. 4) or within any suitable local or remote storage device. Even though these data storage units are depicted as separate units, they may be located within the same physical memory or even within the same media guidance data databases.

When an interactive media guidance application is operating on user equipment 610, user interface generation engine 650 retrieves the media guidance application data from the media guidance data storage in order to generate media displays. Thus, user interface generation engine 650 is able to seamlessly generate media displays within a media guidance application based on the available media guidance data and irrespective of the quality measure value of the guidance data.

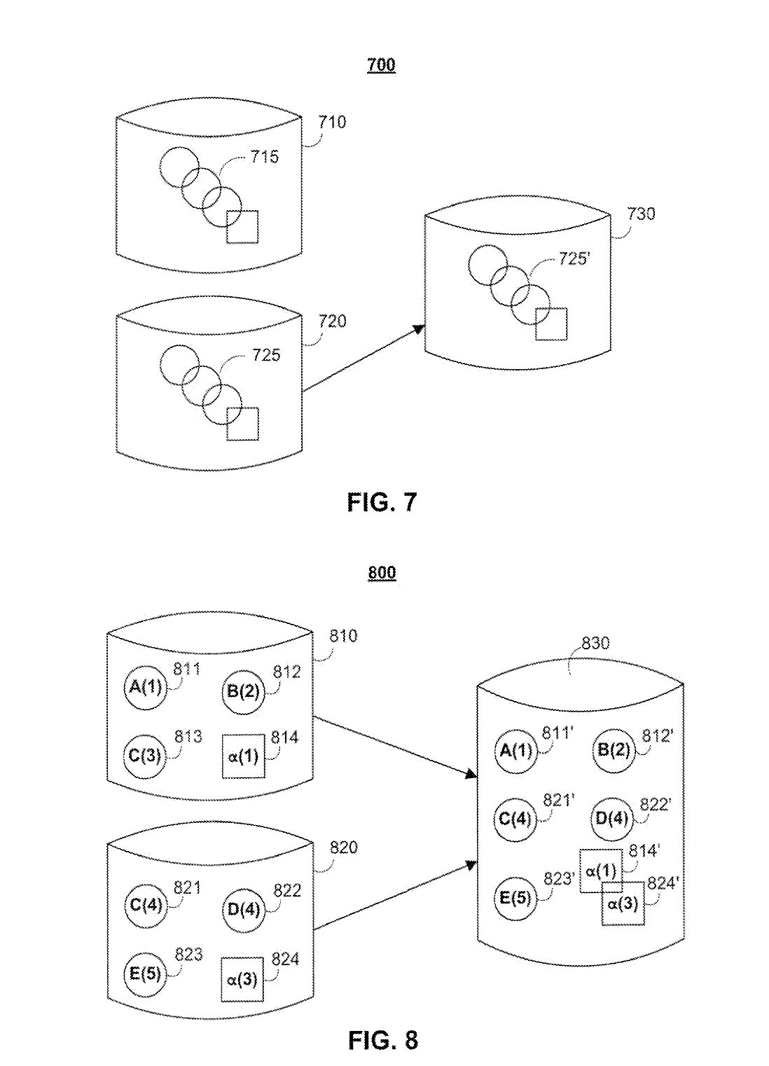

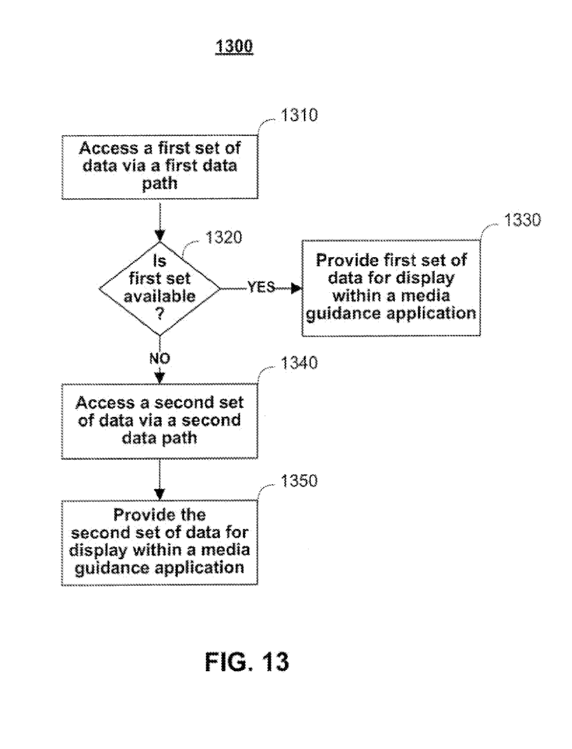

User interface generation engine 650 may retrieve the media guidance application data by requesting the data from proxy server 640. In response to the request, proxy server 640 may determine what guidance application data is available from media guidance data storage 625 and 635, select a set of media guidance data, and provide the selected data to user interface generation engine 650. Proxy server 630 may also provide portions from multiple data sets to create a combined or merged data set. For example, proxy server may select a set of media guidance data or a portion of a set of media guidance data based on the source of the data set, the data path on which the data set was received, quality measure value of the data set, a time value associated with the data sets, user device settings, media guidance application settings, user preferences, or some combination of these factors. Illustrative techniques for determining what media guidance application data is available and selecting a set of media guidance application data to be displayed in an interactive media guidance application will be described in greater detail below with respect to diagrams of FIGS. 7 and 8 and the flowcharts of FIGS. 13-16. While the current embodiment relates to a user equipment device that receives two sets of media guidance data, it should be understood that the techniques described herein may be used with any number of data sets.

FIG. 7 shows diagram 700 which illustrates an exemplary technique for accessing multiple interchangeable media guidance data sets and selecting one of the media guidance data sets. Data storage 710 contains a first media guidance data set 715 and data storage 720 contains a second media guidance set 725. For example, media guidance data set 715 may have been received from a broadcast source such as broadcast source 603 (FIG. 6) and media guidance data set 725 may have been received from an Internet source such as Internet source 605. After both media guidance data sets 715 and 725 are accessed, data set 725 is selected and is provided to data storage 730 for use by a media guidance application. Data storage 730 may be a separate physical data storage or may be a logical representation of the data made available to an interactive media guidance application. For example, data storage 730 may represent the media guidance data provided by proxy server 640 (FIG. 6) to user interface engine 650 based on the data available from data storage 625 and 635. Data set 725 may be selected because it was received from a data source or over a data path with a higher priority than data set 715 and/or because it is associated with a higher quality measure value than data set 715. Even though data sets 715 and 725 may be considered interchangeable, it should be understood that data set 725 may contain additional data that is not contained in data set 715 and vise versa. However, generally speaking, if additional data is contained in the unselected data set and if it would be desirable to provide that additional data with the selected data set, the additional data from the unselected data set may also be provided to data storage 730. Further criteria for selecting between two interchangeable data sets will be described in greater detail below.

FIG. 8 shows diagram 800 which illustrates an exemplary technique for accessing two media guidance application data sets and merging the two data sets to create a combined media guidance application data set. Data storage 810 contains a first media guidance data set and data storage 820 contains a second media guidance set. Data storage 810 contains three data files A 811, B 812, and C 813 and a user-interface rendering file α 814. Files 811-814, taken together, represent an illustrative media guidance data set. Of course, a media guidance data set can include any number of different files and file types, but the number has been kept small for ease of explanation. Similarly, while referred to as files, files 811-814 may be any unit of data including bits, bytes, packets, frames, files, file directories, etc. and may contain data organized in any suitable format. Data files 811-813 may contain the data that may be used by a media guidance application to generate media guidance display screens. The data within data files 811-813 may be organized according to a standard format such as Extensible Markup Language (XML) or other suitable format in order to increase compatibility with media guidance applications. However, any suitable standard or non-standard format may be used for the data files.

Each file 811-814 may be associated with a quality measure value, which may be a measure of the type of data included with a particular file or data set. For example, file A 811 is associated with a quality measure value of 1, file B 812 is associated with a quality measure value of 2, file C 813 is associated with a quality measure value of 3, and file α 814 is associated with a quality measure value of 1. According to an exemplary quality measure value ranking scheme, quality measure values of 1 and 2 may correspond to relatively basic media guidance data such as broadcast times, broadcast channels, media titles, media descriptions, ratings information. Display 100 shown in FIG. 1 is an illustrative media guidance display screen that may be generated from basic guidance data. A quality measure value of 3 may correspond to moderate guidance data such as relatively simple graphics (e.g., network logos or program logos) that may be added to the basic guidance data in a guidance application display. Finally, quality measure values of 4 and 5 may correspond to enhanced guidance data such as more advanced graphics and video data that may supplement or replace portions of the basic and moderate guidance data. Display 300 shown in FIG. 3 is an illustrative media guidance display screen that may be generated using enhanced guidance data. It should be understood that this quality measure value ranking scheme and the differentiation between basic, moderate, and enhanced guidance data is merely exemplary of one possible ranking scheme. Any other suitable method of ranking quality measure values and differentiations between different types of guidance data may also be used.

In some embodiments, the quality measure values of the media guidance data may be specifically indicated by the data files, as shown in FIG. 8. These values may be determined by the media guidance data source or at any other suitable point responsible for the creation or distribution of the guide data. In some other embodiments, the media guidance value may be determined, by a user equipment device that receives the media guidance data or a media guidance application operating on the device. For example, proxy server 640 (FIG. 6) may determine media guidance values for the media guidance data stored in data storage 810 and 820. A media guidance value may be determined by analyzing the media guidance data, for example, to determine whether the media guidance data is basic, moderate, or advanced. Alternatively, the media guidance value may be determined based on the source or data path from which the media guidance data was received. The determined media guidance data value may be an absolute value (as illustrated in FIG. 8) or a relative ranking between two of more media guidance data sets (not shown).

Data storage 810 also includes user-interface rendering file α 814. User-interface rendering file a (814 may be used by a media guidance application to generate display screens or display modules using the media guidance data. While it is contemplated that the user devices and media guidance applications are able to generate media guidance displays (e.g., using user-interface generation engine 650 (FIG. 6)) without requiring a user-interface rendering file, in some instances it may be beneficial to include user-interface rendering information with the media guidance data. For example, user-interface rendering file α 814 may be provided as a backup. Furthermore, user-interface rendering file α 814 may provide an improved or different display from the display that would otherwise be generated by the media guidance application. For example, user-interface rendering file α 814 may be used to generate a display screen that is more closely tailored to the media guidance data set or that is newer than the display that would be generated by the media guidance application. When a user-interface rendering file is provided, but is not required to generate the display, the media guidance application may chose whether or not to use the user-interface based on any number of factors, including, for example, a quality factor associated with the user-interface rendering file, a quality factor associated with the media guidance application's native display, the source of the user-interface rendering file, the type of user equipment device or platform, user preferences, or any other suitable factor.

Returning to illustration of diagram 800, data storage 820 contains three data files C 821, D 822, and E 823 and a user-interface rendering file α 824. Files 821-824, taken together, represent a second illustrative media guidance data set. As with files 811-814, files 821-824 are each associated with media guidance values. In the current example, only files C 813 and C 821 are interchangeable. Data storage 810 and 820 may be combined to form data storage 830. Thus, instead of providing data from only one data set as illustrated above in FIG. 7, in this illustrative embodiment data storage 830 is provided one version each of data files A-E and two different versions of user-interface rendering file α from the two data sets. Data storage 830 may be a separate physical data storage or may be a logical representation of the data made available to an interactive media guidance application. A media guidance application display may be generated from the combined guidance data from data storage 830, with the data from data storage 810 providing the basic guidance data (i.e., files 811, 812, and 814) and being supplemented by the enhanced guidance data from data storage 820 (i.e., data files 821-824). When interchangeable data files are available from both data sets, data storage 830 may contain only one copy of that data file. Thus, because data files C 813 and C 821 are interchangeable, only one of these data files is provided within combined data storage 830. In particular, file C 813 has a quality measure of 3 and file C 821 has a quality measure value of 4, which may indicate that file C 821 should be given priority over interchangeable data file C 813. The difference between the quality measure values of data files C 813 and C 821 may be based on the type of guidance data contained in the data files, the data source or data path by which the data files were received, or any other suitable factors. Further, where interchangeable data file have similar quality measure values, one of the data files may be selected based on the data source or data path by which the files were received, time values associated with the files, or any other suitable factors.

In some instances, combined data storage 830 may contain all available guidance data sets and guidance data files (e.g., files 811-814 and file 821-824), even interchangeable sets and files. This may provide an interactive guidance application with all of the available guidance data. For example, combined data storage 830 contains both interchangeable user-interface rendering files α 814 and α 829. Similarly in some instances, some non-interchangeable files may be omitted from combined data storage 830 if they are not required to generate an interactive media guidance application display. For example, data file A 811 may be omitted from combined data storage 830, even if it is not interchangeable with any of the other data files.

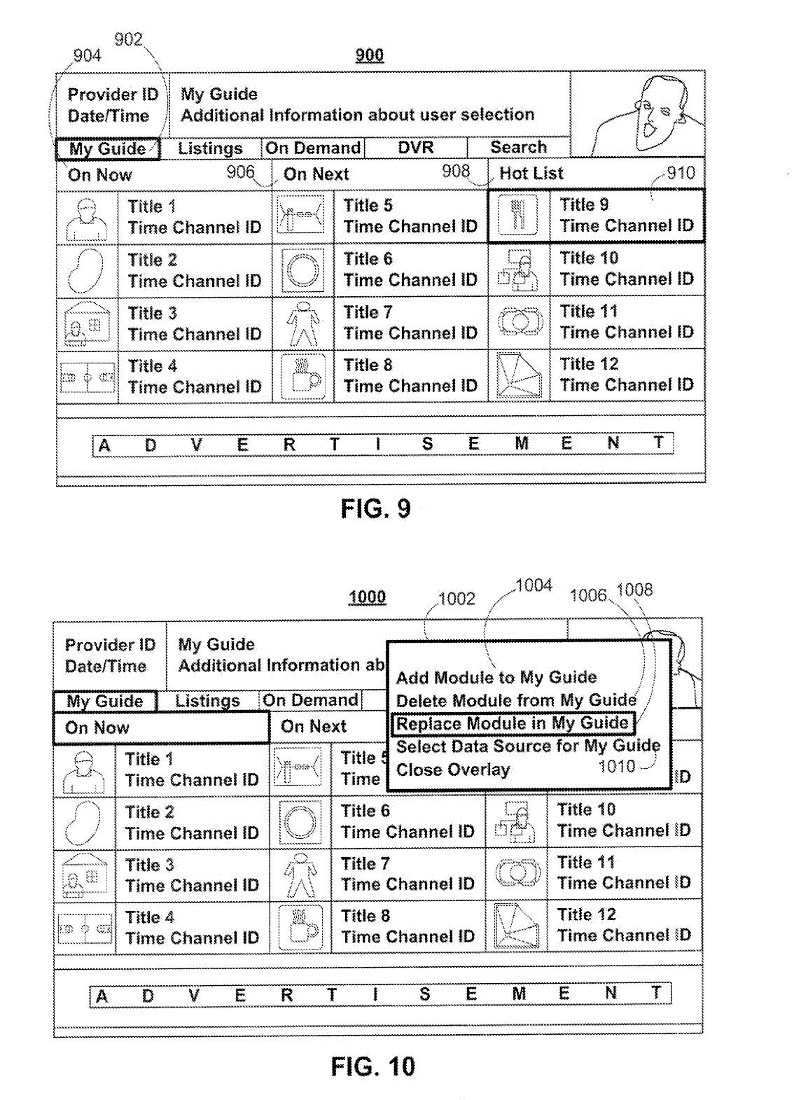

FIG. 9 illustrates display 900, which is an example of a display that can display modules generated from the media guidance data sets described above. Display 900 is illustrated as a modular media guidance dashboard application display, sometimes referred to herein as a dashboard. Although display 900 includes tabs region 902, which is similar to or same as tabs region 214 of FIG. 2, one skilled in the art would appreciate that display 900 may be presented in response to, e.g., receiving a user selection of an option from any type of display (such as, e.g., one of selectable options 302 in display 300), logging in to the guidance application, etc.

Display 900 illustrates a customizable interactive user interface that includes On Now module 904, On Next module 906 and Hot List module 908. These particular modules may be included in display 900 for various reasons. For example, a user profile may cause one or more of these modules to be included in display 900. As another example, the user may have specifically selected one or more of the modules to be included in display 900.

As illustrated, each module is associated with media files, and each media file can have at least one corresponding media listing, which may be selected. The modules may be able to interchangeably display guidance data associated with the media listings having various quality measure values. For example, depending on the available media guidance data sets, modules may contain basic media guidance application data such as text-based listing and icons or enhanced media guidance application data including more advanced graphics and video. A user can utilize a user input device to navigate highlight region 910 to surround and select any of the media listings. In response to a listing being selected, the media guidance application may generate a new display, which may include retrieving data and presenting media or information to a user, and/or performing any other command associated with the selected media listing (e.g., scheduling a program for recording, setting a reminder, associating a program with a favorites list or user profile, etc.).

On Now module 904, On Next module 906 and Hot List module 908 are the only three modules included in display 900. Additional or fewer modules may be included in display 906, just like any other display of the present invention. In some embodiments, particular modules are automatically associated with particular displays by the media guidance application. In other embodiments, the user may configure how many and which modules can be included in any given display or what type of media guidance data is preferred (e.g., basic or enhanced). For example, display 900 may be limited to only three modules and may be configured to include one or more recommended modules with the most enhanced media guidance application data available. Such configurations, like all other user-specified settings are saved as user preference data, or more generally as a file of user data.

Display 1000 of FIG. 10 illustrates an exemplary display that may be presented to the user in response to the media guidance application receiving a user indication to manually configure (or reconfigure) which the modules are included in, e.g., display 900. Display 1000 includes overlay 1002. Overlay 1002 may include selectable options, such as, e.g., add module option 1004, delete module option 1006, replace module option 1008, select data source option 1010. In some instances, the options included in overlay 1002 can be module-specific and displayed in response to a portion of a module being selected (such as, e.g., an icon (not shown), the module header (i.e., the portion of the module that includes the module name), etc.). In other instances, overlay 1002 can be generic and the media guidance application may ask the user to associate a module with a selected option after the option is selected. For example, in response to add module option 1004 being selected, the interactive media guidance application may generate a display that allows the user to add a module to display 1000. As another example, in response to delete module option 1006 being selected, the interactive media guidance application may generate a display that allows the user to delete the association of a module with display 1000. As yet another example, in response to the select data source option 1010, the interactive media guidance application may generate a display the allows the user to manually select a data source for use in generating a module. Other options may allow a user to set a priority for data sources and may allow a user to specify a preferred media guidance application display level (e.g., basic or enhanced).

FIGS. 11A and 11B show an illustrative Sports Programs module that may be added to display 1000 (FIG. 1000). Both figures show the same illustrative media guidance application display module which lists three sports programs scheduled to be broadcast on a particular evening. However, FIG. 11A illustrates the display module generated from a basic media guidance application data set and FIG. 11B illustrates the same display module generated from an enhanced media guidance application display set. In FIG. 11A, the listings information includes the team name, the date and time of game, the channel name, and the channel logos 1101-1103. In FIG. 11B, the same listings information is provided with the addition of high-resolution video thumbnails 1111-1113 for each program and updated status information 1121 and 1122 for some of the programs. Thus it can be seen that within the same media guidance application display module, the information provided may be different based on the selected media guidance application data set. In addition to the differences illustrated, if the enhanced media guidance application data set is received over a two-way data path such as an Internet path the module illustrated in FIG. 11B may be further customized the user. For example, a user may specify preferred teams or sports or request additional information associated with the listings in FIG. 11B.

If only a portion of the enhanced media guidance application data set is available, the available portion may be displayed with the remaining portions of the basic media guidance application data set. For example, if only high-resolution video thumbnail 1111 were available, thumbnail 1111 may be displayed along with logos 1102 and 1103. Thus, the display module seamlessly degrades when enhanced guidance data which was once provided is no longer available or usable. This may occur, for example, when an Internet data path is provided to a user equipment device and cached by the device and then the Internet path is removed and the cached data becomes out-of-date. When a set of media guidance application data is received, but is incomplete, out-of-date, or is otherwise unsuitable for display, this data set may be considered unavailable either in part or in whole.

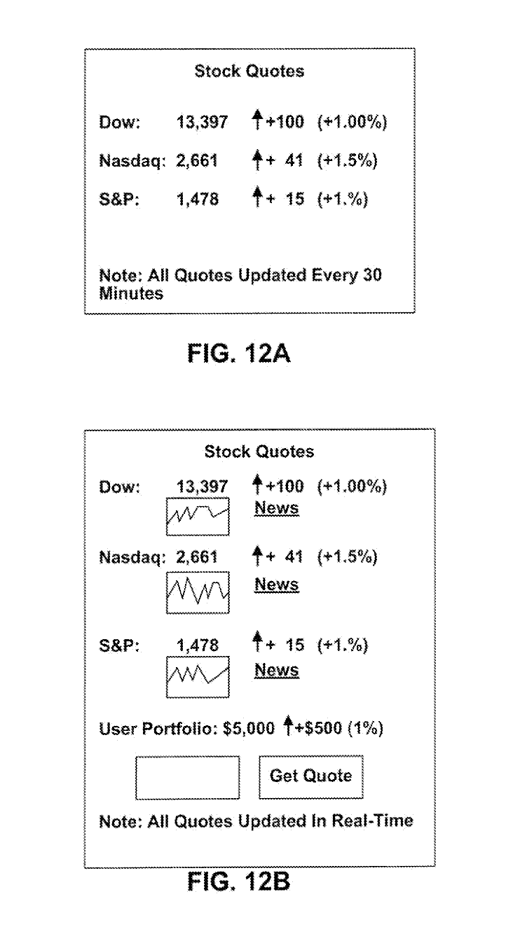

In addition to media guidance application display modules, interactive information modules may also be provided that may be generated from available media guidance application data sets. FIGS. 12A and 12B both show the same illustrative Stock Quotes module which may be added to display 1000 (FIG. 1000). FIG. 12A illustrates the display module generated from a basic media guidance application data set received over a one-way communications path and FIG. 11B illustrates the same display module generated from an enhanced media guidance application display set received over a two-way communications path. In FIG. 12A, stock quotes for major stock indices are received and updated every thirty minutes based on the refresh rate of the basic media guidance application data set. In FIG. 11B, the same stock quotes are provided, but they are updated in real-time instead of every thirty minutes. FIG. 11B also contains interactive services such as stock charts, stock news, user-defined portfolio quotes, and an interactive stock quote lookup.

In addition to the interactive media guidance application modules illustrated in FIGS. 11 and 12, which may be able to provide different display features depending on the available media guidance application data, some modules may be provided only when a particular data set is available. For example, a “Video Clip” module that displays video previews of particular programs may only be provided when a media guidance application data set that contains video clips is available. In other words, this exemplary module may only be provided when a media guidance application data set having an associated quality measure above a particular threshold is available. In addition, some media guidance application data sets may include modules (e.g., via user-interface rendering files) that are not included with other data sets. For example, an enhanced media guidance application data set may include modules that are not included with an interchangeable basic media guidance application data set.

Further to the discussion above, exemplary methods for accessing and selecting multiple media guidance application data sets are discussed below. FIG. 13 shows process 1300, which can be used to retrieve data over multiple data paths for display within a display module of an interactive media guidance application. At step 1310 a first set of media guidance application data is accessed via a first data path. This first set of media guidance application data is given priority over other media guidance application data sets received over other data paths. For example, the first set of media guidance application data may be enhanced media guidance application data received over an Internet path. If at step 1320 it is determined that the first set of media guidance application data is available, the first set of media guidance application data is displayed within a media guidance application at step 1330. If, however, the first set of media guidance application data is not available, at step 1340 a second set of media guidance application data is accessed via a second data path and at step 1350 this data is displayed within a media guidance application. This process may be extended for multiple media guidance application data sets and for partial or incomplete data sets.

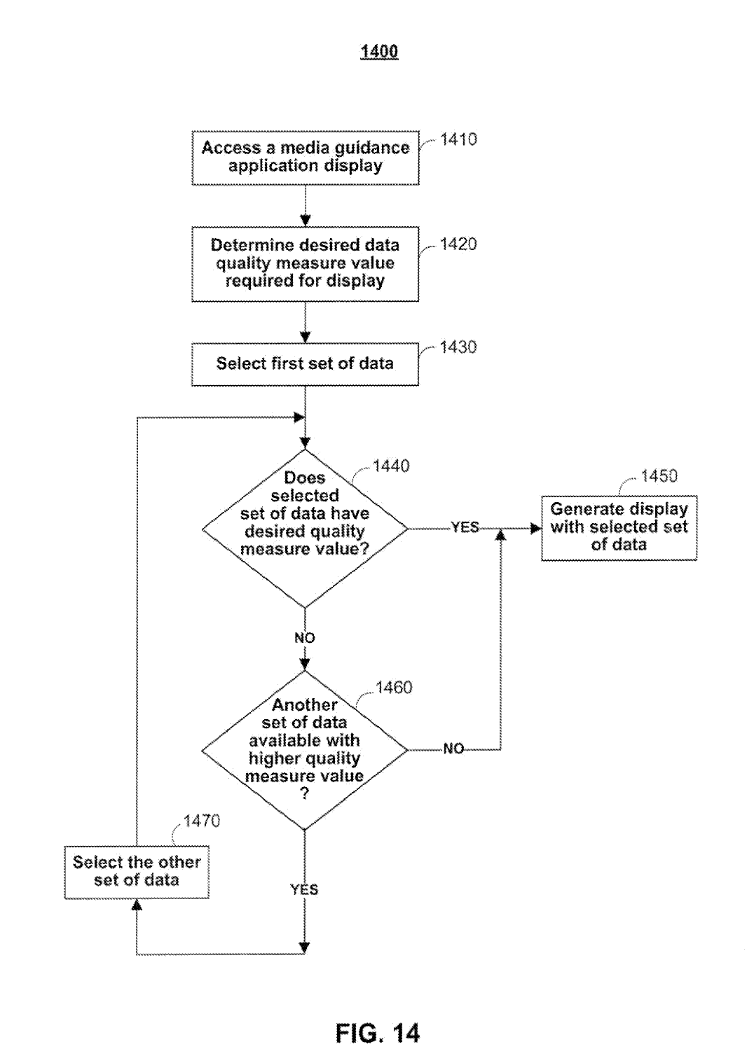

FIG. 14 shows process 1400, which can be used to retrieve multiple media guidance application data sets and to select one of the data sets in order to generate an interactive media guidance application display. At step 1410, an interactive media guidance application display is accessed from an interactive media guidance application. Then, at step 1420, a desired quality measure value is determined for the media guidance application data. The desired quality measure value may be based on, for example, the type of user device or platform, the type of media guidance application display, user preferences, etc. At step 1430, a first set of media guidance application data is selected. At step 1440, it is determined whether the selected set of media guidance application data meets the desired quality measure value. If the selected data meets the desired quality measure value, at step 1450, the display is generated with the selected data set. If the data does not meet the desired quality measure value, at step 1460 it is determined whether another set of media guidance application data is available with a higher quality measure value. If another set of media guidance application data is available, then at step 1470, the other set is selected. Steps 1440 and 1460 are repeated until a set of media guidance data is selected that meets the desired quality measure value or until no other data sets are available with higher quality measure values. If no other data sets are available with higher quality measure values, the display is generated with the selected data set at step 1450.

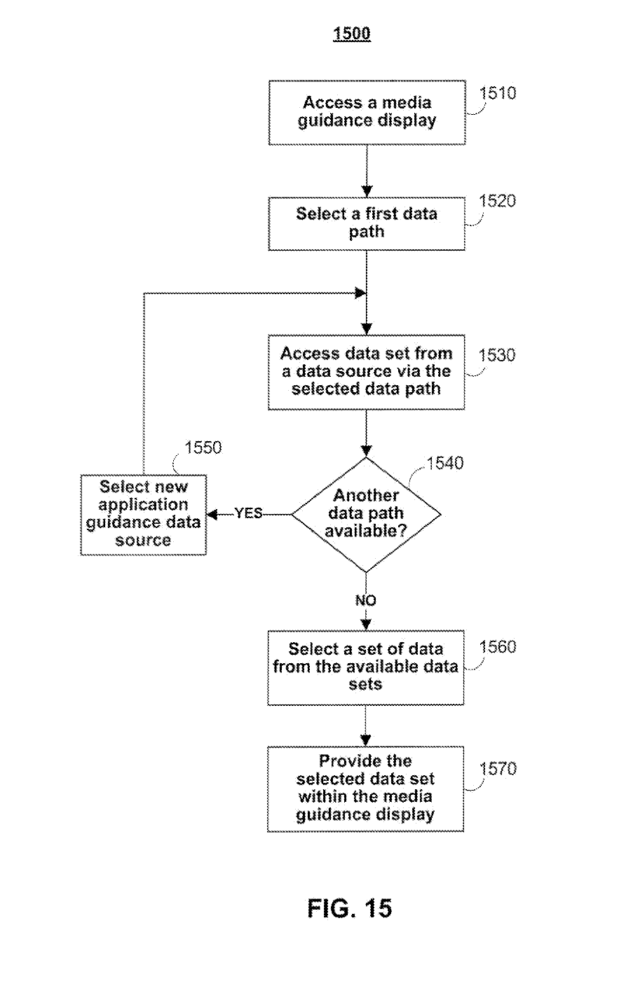

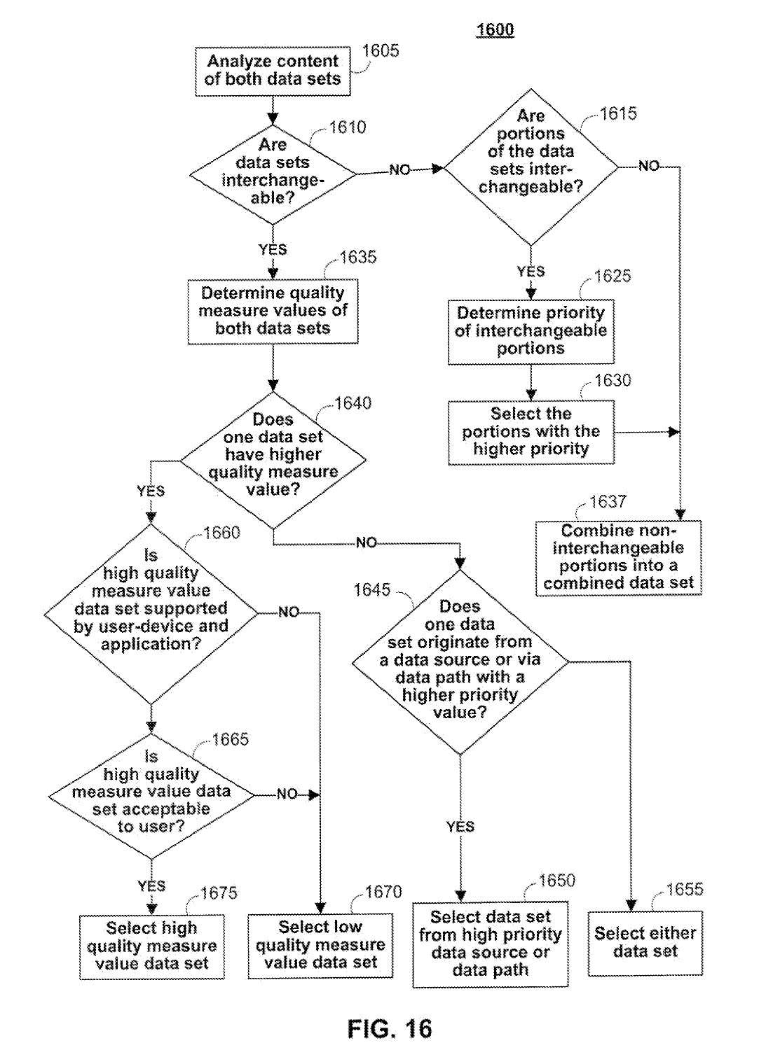

FIG. 15 shows process 1500, which may also be used to retrieve multiple media guidance application data sets and to select one of the data sets in order to generate an interactive media guidance application display. At step 1510, an interactive media guidance application display is accessed from an interactive media guidance application. At step 1520 a first media guidance data path is selected and at step 1530 a media guidance application data set is accessed from a data source via the selected data path. If other data paths (to the same data source or to other data sources) are available, they are selected and additional media guidance application data sets are accessed at steps 1540, 1550, and 1530. When all of the available data sets have been accessed, a set of media guidance data is selected from the available data sets at step 1560. An illustrative process for selecting a set of media guidance data from multiple data sets is shown in FIG. 16. Finally, the selected data set is provided with the media guidance display at step 1570.

FIG. 16 shows process 1600, which can be used to select a set of media guidance application data from multiple sets of media guidance application. In particular, process 1600 can be used to select one media guidance application data set from two media guidance application data sets. It should be understood that this same process may also be used to select from any number of media guidance application data sets. At step 1605 the content of both data sets is analyzed. Based on this analysis, at step 1610, it is determined whether the two data sets are interchangeable. As explained above, two data sets are interchangeable when either data set may be used to generated a particular media guidance application display. If the two data sets are not interchangeable, the data sets may be merged to provide a combined data set. For example, a media guidance application data set having basic guidance application data may be merged with a data set having enhancements to the basic data (without having the basic data itself) to form an enhanced media guidance application data set.

At step 1615, it is determined whether any portions of the data sets are interchangeable. For example, it is determined whether or not there are data files within the data sets that are interchangeable. If there are interchangeable portions, at steps 1625 and 1630 the priority of the interchangeable portions are determined and the portions with the higher priority are selected. Criteria for determining the priority of interchangeable portions may be the same as the criteria for selecting between interchangeable data sets which will be discussed below. At step 1633, the non-interchangeable portions of the data sets may be merged into a combined data set.

If the data sets are interchangeable then only one of the data sets will be selected. At step 1635, quality measure values for the data sets may be determined. As discussed above with respect to FIG. 8, there are a number of ways to determine quality measure values for a data set. For example, the quality measure values may be assigned an objective quantity or may be given a subjective ranking. At step 1640, the quality measure values of the two data sets are compared. If neither of the data sets has a higher quality measure value, at step 1645 it is determined whether the either of the data sets were received from a data source or a data path having a higher priority. For example, an Internet path may be given a higher priority than a cable broadcast path. If there is a difference in priority, at step 1650 the data set from the higher priority data source or data path is selected. If not, at step 1655 either data set may be selected.

If one of the data sets has a higher quality measure value than the other data set, the data set with the higher quality measure value is selected at step 1675 unless there is a reason to select the data set with the lower quality measure value. For example, the data set with the lower quality measure value may be selected at step 1670 if the media guidance application data associated with the higher quality measure value is not supported by the user device or by the media guidance application display (step 1660) or if specified by a user preference setting (step 1665).

The processes discussed above are intended to be illustrative and not limiting. One skilled in the art would appreciate that steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes.

What is claimed is:

1. A method for displaying data within an interactive media guidance application on a device, the method comprising:
accessing via a first data path a first set of the data to be displayed within the interactive media guidance application;
accessing via a second data path a second set of the data to be displayed within the interactive media guidance application;
determining the availability of the first set of the data delivered via the first data path;
providing the first set of the data for display within the interactive media guidance application if the first set of data delivered via the first data path is available; and
providing the second set of the data for display within the interactive media guidance application if the first set of data being delivered via the first data path is not available.

2. The method of claim 1, wherein the first data path is a high-bandwidth data stream and the second data path is a low-bandwidth data stream.

3. The method of claim 1, wherein the first data path is an Internet connection.

4. The method of claim 1, wherein the second data path is a broadcast transmission.

5. The method of claim 1, wherein the broadcast transmission includes at least one of an over-the-air transmission, a cable transmission, and a satellite transmission.

6. The method of claim 1, wherein the first set of the data is available only when the device is connected to the Internet.

7. The method of claim 1, wherein the second set of the data to be displayed within the interactive media guidance application is accessed via the second data path only if the first set of the data being delivered via the first data path is not available.

8. The method of claim 1, wherein the first set of the data has a higher quality measure value than the second set of the data.

9. The method of claim 1, wherein the second set of the data consists of text-only data and the first set of the data consists of graphics and text data.

10. The method of claim 1, wherein the first set of data is interchangeable with the second set of data.

11. The method of claim 10, wherein the first set of data contains additional data not included in the second set of data.

12. A system for displaying data within an interactive media guidance application, the system comprising:
user equipment on which a user media guidance application is implemented, wherein the media guidance application is configured to:
access via a first data path a first set of the data to be displayed within the interactive media guidance application;
access via a second data path a second set of the data to be displayed within the interactive media guidance application;
determine the availability of the first set of the data delivered via the first data path;
provide the first set of the data for display within the interactive media guidance application if the first set of data delivered via the first data path is available; and
provide the second set of the data for display within the interactive media guidance application if the first set of data being delivered via the first data path is not available; and
a display screen that displays the interactive guidance application to the user.

13. The system of claim 12, wherein the first data path is a high-bandwidth data stream and the second data path is a low-bandwidth data stream.

14. The system of claim 12, wherein the first data path is an Internet connection.

15. The system of claim 12, wherein the second data path is a broadcast transmission.

16. The system of claim 12, wherein the broadcast transmission includes at least one of an over-the-air transmission, a cable transmission, and a satellite transmission.

17. The system of claim 12, wherein the first set of the data is available only when the device is connected to the Internet.

18. The system of claim 12, wherein the second set of the data to be displayed within the interactive media guidance application is accessed via the second data path only if the first set of the data being delivered via the first data path is not available.

19. The system of claim 12, wherein the first set of the data has a higher quality measure value than the second set of the data.

20. The system of claim 12, wherein the second set of the data consists of text-only data and the first set of the data consists of graphics and text data.

21. The system of claim 12, wherein the first set of data is interchangeable with the second set of data.

22. The system of claim 21, wherein the first set of data contains additional data not included in the second set of data.

23. A system for displaying data within an interactive media guidance application on a device, the system comprising:
means for accessing via a first data path a first set of the data to be displayed within the interactive media guidance application;
means for accessing via a second data path a second set of the data to be displayed within the interactive media guidance application;
means for determining the availability of the first set of the data delivered via the first data path;
means for providing the first set of the data for display within the interactive media guidance application if the first set of data delivered via the first data path is available; and
means for providing the second set of the data for display within the interactive media guidance application if the first set of data being delivered via the first data path is not available.

24. The system of claim 23, wherein the first data path is a high-bandwidth data stream and the second data path is a low-bandwidth data stream.

25. The system of claim 23, wherein the first data path is an Internet connection.

26. The system of claim 23, wherein the second data path is a broadcast transmission.

27. The system of claim 23, wherein the broadcast transmission includes at least one of an over-the-air transmission, a cable transmission, and a satellite transmission.

28. The system of claim 23, wherein the first set of the data is available only when the device is connected to the Internet.

29. The system of claim 23, wherein the second set of the data to be displayed within the interactive media guidance application is accessed via the second data path only if the first set of the data being delivered via the first data path is not available.

30. The system of claim 23, wherein the first set of the data has a higher quality measure value than the second set of the data.

31. The system of claim 23, wherein the second set of the data consists of text-only data and the first set of the data consists of graphics and text data.

32. The system of claim 23, wherein the first set of data is interchangeable with the second set of data.

33. The system of claim 32, wherein the first set of data contains additional data not included in the second set of data.

34. A method for displaying media guidance data within an interactive media guidance application on a device, the method comprising:
displaying on the interactive media guidance application media guidance data accessed via a first data path; and
displaying on the interactive media guidance application media guidance data accessed via a second data path when access to the first data path is unavailable.

35. The method of claim 34, wherein the first data path is a high-bandwidth data stream and the second data path is a low-bandwidth data stream.

36. The method of claim 34, wherein the first data path is an Internet connection.

37. The method of claim 34, wherein the second data path is a broadcast transmission.

38. The method of claim 34, wherein the broadcast transmission includes at least one of an over-the-air transmission, a cable transmission, and a satellite transmission.

39. The method of claim 34, wherein the first set of the data is available only when the device is connected to the Internet.

40. The method of claim 34, wherein the media guidance data accessed via the second data path is accessed only if the media guidance data accessed via the first data path is not available.

41. The method of claim 34, wherein the media guidance data accessed via the first data path has a higher quality measure value than the media guidance data accessed via the second data path.

42. The method of claim 34, wherein the media guidance data accessed via the second data path consists of text-only data and the media guidance data accessed via the first data path consists of graphics and text data.

43. The method of claim 34, wherein the media guidance data accessed via the first data path is interchangeable with the media guidance data accessed via the second data path.

44. The method of claim 43, wherein the media guidance data accessed via the first data path contains additional data not included in the media guidance data accessed via the second data path.

45. A system for displaying data within an interactive media guidance application, the system comprising:
user equipment on which a user media guidance application is implemented, wherein the media guidance application is configured to:
provide the interactive media guidance application media guidance data accessed via a first data path; and
provide the interactive media guidance application media guidance data accessed via a second data path when access to the first data path is unavailable; and
a display screen that displays the interactive guidance application to the user.

46. The system of claim 45, wherein the first data path is a high-bandwidth data stream and the second data path is a low-bandwidth data stream.

47. The system of claim 45, wherein the first data path is an Internet connection.

48. The system of claim 45, wherein the second data path is a broadcast transmission.

49. The system of claim 45, wherein the broadcast transmission includes at least one of an over-the-air transmission, a cable transmission, and a satellite transmission.

50. The system of claim 45, wherein the first set of the data is available only when the device is connected to the Internet.

51. The system of claim 45, wherein the media guidance data accessed via the second data path is accessed only if the media guidance data accessed via the first data path is not available.

52. The system of claim 45, wherein the media guidance data accessed via the first data path has a higher quality measure value than the media guidance data accessed via the second data path.

53. The system of claim 45, wherein the media guidance data accessed via the second data path consists of text-only data and the media guidance data accessed via the first data path consists of graphics and text data.

54. The system of claim 45, wherein the media guidance data accessed via the first data path is interchangeable with the media guidance data accessed via the second data path.

55. The system of claim 45, wherein the media guidance data accessed via the first data path contains additional data not included in the media guidance data accessed via the second data path.

56. A system for displaying media guidance data within an interactive media guidance application on a device, the system comprising:
means for displaying on the interactive media guidance application media guidance data accessed via a first data path; and
means for displaying on the interactive media guidance application media guidance data accessed via a second data path when access to the first data path is unavailable.

57. The system of claim 56, wherein the first data path is a high-bandwidth data stream and the second data path is a low-bandwidth data stream.

58. The system of claim 56, wherein the first data path is an Internet connection.

59. The system of claim 56, wherein the second data path is a broadcast transmission.

60. The system of claim 56, wherein the broadcast transmission includes at least one of an over-the-air transmission, a cable transmission, and a satellite transmission.

61. The system of claim 56, wherein the first set of the data is available only when the device is connected to the Internet.

62. The system of claim 56, wherein the media guidance data accessed via the second data path is accessed only if the media guidance data accessed via the first data path is not available.

63. The system of claim 56, wherein the media guidance data accessed via the first data path has a higher quality measure value than the media guidance data accessed via the second data path.

64. The system of claim 56, wherein the media guidance data accessed via the second data path consists of text-only data and the media guidance data accessed via the first data path consists of graphics and text data.

65. The system of claim 56, wherein the media guidance data accessed via the first data path is interchangeable with the media guidance data accessed via the second data path.

66. The system of claim 56, wherein the media guidance data accessed via the first data path contains additional data not included in the media guidance data accessed via the second data path.
